(19) United States
(12) Patent Application Publication
(10) Pub. No.: US 2007/0083917 A1
(43) Pub. Date: Apr. 12, 2007

(54) Apparatus system and method for real-time migration of data related to authentication

(76) Inventors: Matthew T. Peterson, Lindon, UT (US); Jackson Shaw, Bellevue, WA (US)

Correspondence Address: UTAH VALLEY PATENT SERVICES, LLC, 846 S. 1350 E., PROVO, UT, 84606, US

(21) Appl. No.: 11/246,496

(22) Filed: Oct. 7, 2005

(51) Int. Cl. H04L 9/32

(52) U.S. Cl. 726/5

(57) ABSTRACT

The present invention facilitates deploying a new authentication protocol in an established application environment. In one embodiment, an authentication credential is intercepted by a migration module that determines whether data associated with the specified account needs to be migrated from an established server to a target authentication server. A binding module may redirect authentication credentials intended for the established server to the migration module. In one embodiment, new user accounts may be added on the target authentication server, if specified by configuration options. Data associated with user accounts such as titles, telephone numbers, addresses, or the like may be migrated from the established server to the target server with the authentication data.

### BACKGROUND OF THE INVENTION

1. Field of the Invention

The present invention relates to migration of data related to authentication. Specifically, the invention relates to apparatus, methods, and systems for real-time migration of data related to authentication.

2. Description of the Related Art

A significant obstacle to the adoption of new authentication technologies is the effort involved in migrating authentication data from existing servers to new systems. Managing the migration of such data typically requires considerable planning as well as frequent manual intervention. The magnitude of the difficulty involved is multiplied when the existing servers are accessed from a plurality of locations. For example, a corporation may want to migrate accounts that employees in many offices use to manage their benefits from one server on the corporate intranetwork to another. Similarly, an internet-based business may want to migrate its customer accounts to a new server.

In particular, internet accessible accounts and applications magnify several problems for IT departments. First, the internet may provide access to users in much greater numbers. IT managers who traditionally managed hundreds or thousands of users within an organization now face the challenges of managing hundreds of thousands, or even millions of internet users. The second, related, problem is that providing access to applications via the internet enables unsophisticated users, outside the direct control and supervision of the organization's IT department, to use the organization's networked services. Few assumptions can be made about the users' understanding of technology, and whatever user education may be involved in the process of accessing the organization's services could prove an insurmountable obstacle to some users. Furthermore, the organization may not even have a direct communication channel to all of its users to coordinate whatever user actions may be involved in migration to a new authentication system.

Another obstacle to server migration involves the security of authentication systems. Since most secure authentication systems do not store passwords in plain text, passwords on such systems cannot be migrated directly from an established server to a new server. Unix systems, for example, typically generate a hash value from the password, then store only the hash value for use when authenticating users. Normally, the password cannot be deduced from the hash value, and the hash value itself cannot be migrated to another server. The password typically would be available in clear text only when the user logs in. Although it is still possible to create user accounts on a new authentication server corresponding to user accounts on an established server, password migration remains an obstacle to migration.

Given the aforementioned issues and challenges related to migration of authentication data and the shortcomings of currently available solutions, a need exists for an apparatus, method, and system for real-time migration of data related to authentication. Beneficially, such an apparatus, method, and system would migrate authentication data such as user objects, passwords, and the like from an established server to a target server when the user logs in. Preferably, migration would be initiated using methods transparent to the user and procedures with which the user is already familiar, thereby minimizing the amount of education and individual attention required by users during the migration process.

### SUMMARY OF THE INVENTION

The present invention has been developed in response to the present state of the art, and in particular, in response to the problems and needs in the art that have not yet been fully solved by currently available authentication data migration systems. Accordingly, the present invention has been developed to provide an apparatus, method, and system for real-time migration of data related to authentication that overcome many or all of the above-discussed shortcomings in the art.

In one aspect of the present invention, an authentication data migration apparatus includes a migration module that receives authentication credentials from an application and is configured to submit them to an established authentication server and a target authentication server. To migrate authentication data from the established server to the target server, the migration module is also configured to modify authentication data on the target server. For example, in various embodiments the migration module may create or modify user objects or set passwords on the target server.

The apparatus is further configured, in one embodiment, to include a binding module that the migration module may use to locate and communicate with the established server and the target server. In some embodiments, the binding module may also contain configuration parameters for the migration module. For example, the binding module may contain a configurable option that specifies whether the migration module may create new user objects on the target server when a previously unknown user attempts to authenticate to the established server.

In another aspect of the present invention, an authentication data migration method includes redirecting authentication requests from an application to the migration module, receiving a redirected authentication request at the migration module, and migrating authentication data for the particular user from the established server to the target server. In one embodiment, the method includes authenticating the particular user on the target server before migrating authentication data from the established server. In certain embodiments, failure to authenticate the particular user on the target server indicates the need to migrate authentication data for the particular user from the established server to the target server.

In further embodiments, the method may include receiving authentication parameters from a local application. These embodiments enhance the overall security of the method by avoiding the need to transmit credentials in clear text format between an application running on an application server and the migration module running on another server. In another embodiment, the method includes creating user objects on the target server that duplicate user objects on the established server. The method may also include assigning default passwords to user objects on the target server. These embodiments facilitate identifying users that are authorized to be migrated from the established server to the target server.

Various elements of the present invention may be combined into a system arranged to carry out the functions or steps presented above. In one embodiment, the system includes an established server, a target server, and a migration module configured to receive authentication requests and submit them to the established and target servers, with the migration module further configured to modify authentication parameters on the target server. For example, the migration module may, in various embodiments, create user objects on the target server, modify passwords associated with user objects on the target server, migrate attributes associated with user objects on the established server to the target server, or create and assign values to attributes associated with user objects on the target server.

In some embodiments, the system may include an application server hosting both the application that receives credentials from the user and the migration module to which the application directs authentication requests. These embodiments enhance system security by eliminating a communication segment where credentials may be transmitted in clear text format. While the system is versatile enough to be deployed in a number of migration environments, one representative embodiment in which the system may be implemented includes an established Unix server and an Active Directory target server.

The present invention facilitates real-time migration of data related to authentication. These and other features and advantages of the present invention will become more fully apparent from the following description and appended claims, or may be learned by the practice of the invention as set forth hereinafter.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a typical prior art data migrating system;

FIG. 2 is a block diagram illustrating an authentication data migration system of the present invention;

FIG. 3 is a flow chart diagram illustrating one embodiment of an authentication data migration method of the present invention;

FIG. 4 is a flow chart diagram illustrating one embodiment of a user migration method of the present invention; and

FIG. 5 is a network diagram illustrating one embodiment of an authentication data migration system of the present invention.

### DETAILED DESCRIPTION OF THE INVENTION

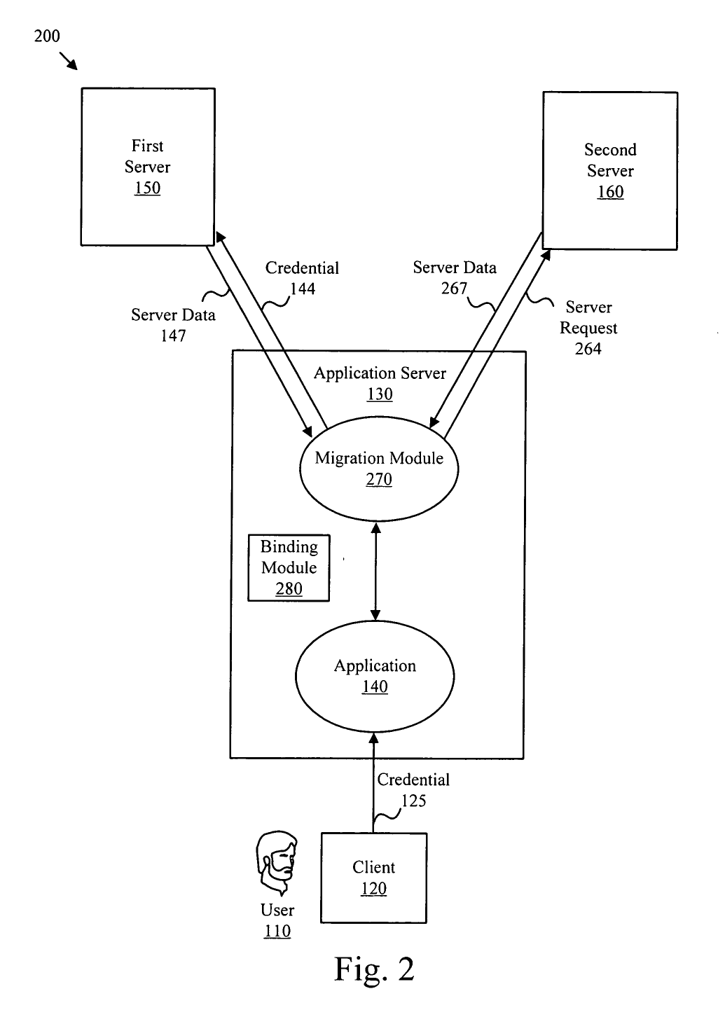

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 2 through 5, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The features, structures, or characteristics of the invention described throughout this specification may be combined in any suitable manner in one or more embodiments. For example, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” or similar language throughout this specification do not necessarily all refer to the same embodiment and the described features, structures, or characteristics may be combined in any suitable manner in one or more embodiments.

The present invention sets forth an apparatus, system and method for real-time migration of data related to authentication. User objects and passwords may be migrated to a new server and operating system as users conduct normal authentication procedures. No interruption in server availability is required, users do not require additional training, and the migration method is transparent to users.

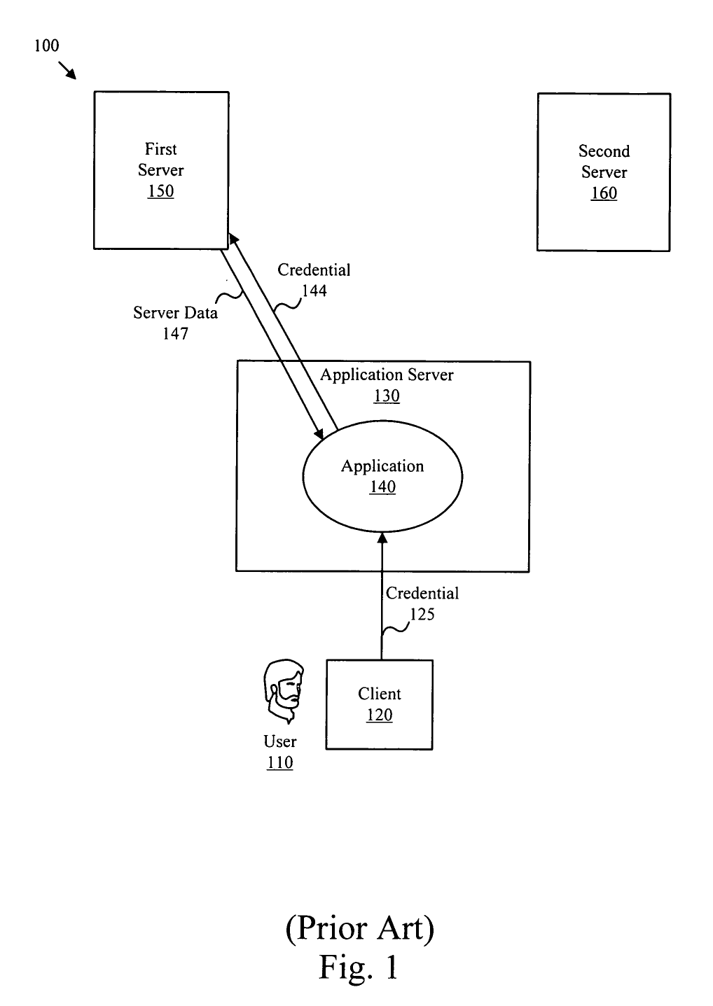

FIG. 1 is a block diagram illustrating a typical prior art authentication data migration apparatus 100. The prior art authentication data migration apparatus 100 includes a user 110, a client workstation 120, a credential 125, an application server 130, an application 140, a credential 144, server data 147, a first server 150 (referred to herein as an established server 150), and a second server 160 (referred to herein as a target server 160). While the apparatus 100 facilitates migration of authentication data, the migration is not automatic and may require significant manual intervention.

Typically, the user 110 enters a credential 125 from the client workstation 120 at the request of the application 140. The credential 125 typically consists of a user name and password. The application passes the credential 144 to the established server 150 to authenticate the user 110, receiving a response from the established server 150 in the form of server data 147 or an authentication denial (not shown).

Introducing a target server 160 creates the need for authentication data to be migrated from the established server 150 to the target server 160. In an environment with sophisticated users, the organization may specify a migration date in which each user 110 must create a new account and password on the target server 160. Even in an environment with a relatively small number of sophisticated users, migration to a target server 160 requires communication with each user 110 to inform them of the need to migrate to the target server 160. Some users may require additional instructions or assistance. In an environment that serves a large number of unsophisticated users, such as online customers, the amount of communication, education, and individual assistance involved quickly makes migration using this method impractical.

FIG. 2 is a block diagram illustrating an authentication data migration system 200 in accordance with the present invention. The authentication data migration system 200 may include components of the prior art authentication data migration apparatus 100 and may additionally include a server request 264, server data 267, a migration module and a binding module 280. The authentication data migration system 200 facilitates migration of data related to authentication from an established server 150 to a target server 160 as each user 110 authenticates to use the application 140.

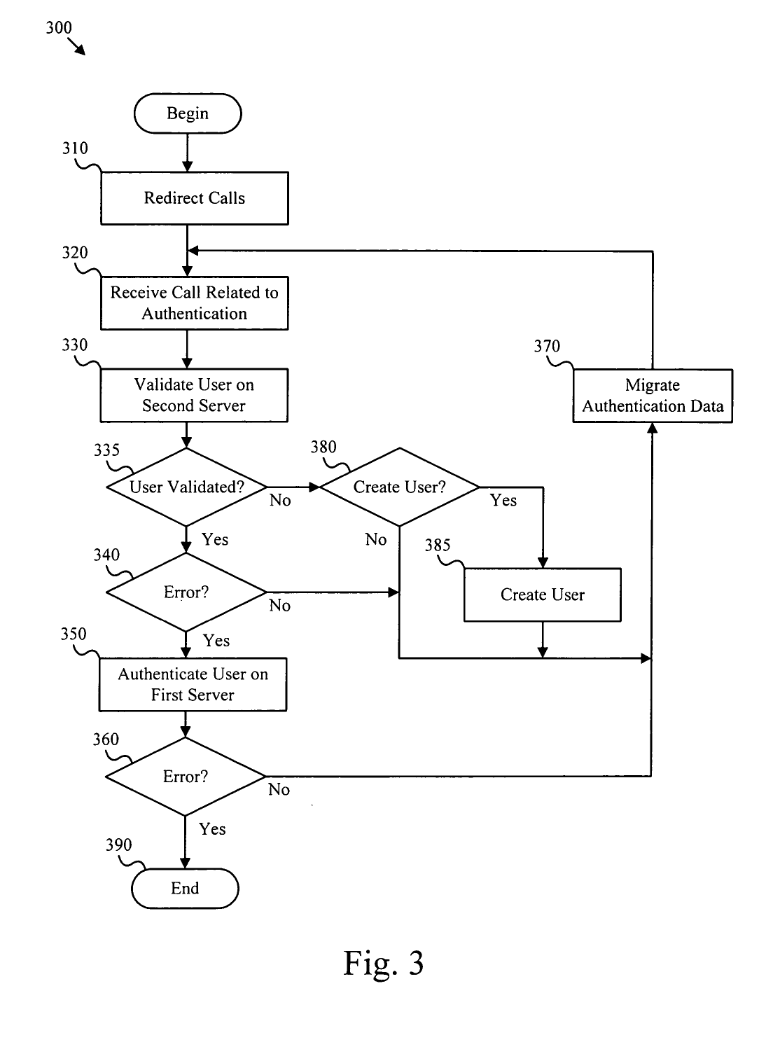

The migration module 270 depicted in FIG. 2 receives the credential 125 from the application 140 and forwards it to the target server 160 via a server request 264. Failure to authenticate to the target server 160 indicates the possibility that the authentication data pertaining to the user 110 has not yet been migrated from the established server 150 to the target server 160. In one embodiment, the migration module 270 submits the credential 144 to the established server 150. Successful authentication to the established server 150 indicates that the user 110 has submitted a valid credential 125, but that the authentication data corresponding to the user has not been migrated to the target server 160. The migration module 270 may then migrate authentication data from the established server 150 to the target server 160. One method used to migrate data related to authentication is described in greater detail in the description of the authentication data migration method 300 depicted in FIG. 3.

In some embodiments, a binding module 280 stores configuration settings used by the migration module 270 to locate the established server 150 and the target server 160. The binding module 280 may contain information required to authenticate users to the established server 150 and the target server 160. The binding module 280 may contain configuration settings pertaining to whether user accounts are to be created or modified on the target server 160. In one embodiment, the binding module 280 is a plain text file. In another embodiment, the binding module 280 is a database. The binding module may also be implemented as part of an existing database on the application server 130. For example, the binding module may be included in a Microsoft Windows registry database or the like.

In one embodiment, migrating authentication data includes creating a user account on the target server 160 corresponding to the user 110. In some embodiments, a user account corresponding to the user 110 may have been created previous to the attempt by to authenticate, and a default password assigned to the user account. In such embodiments, migrating authentication data includes changing the default password to the password entered by the user 110 as part of the credential 125. In some embodiments, migrating authentication data includes creating or assigning values to attributes associated with the user account on the target server 160.

FIG. 3 is a flow chart diagram illustrating one embodiment of an authentication data migration method 300 of the present invention. The authentication data migration method 300 includes a redirect calls operation 310, a receive call operation 320, a validate user operation 330, a user validated test 335, an error test 340, an authenticate user operation 350, an error test 360, a migrate authentication data operation 370, a create user test 380, and a create user operation 385. The authentication data migration method 300 facilitates real-time migration of data related to authentication from an established server 150 to a target server 160 in a manner transparent to the user 110.

The redirect calls operation 310 initializes the migration module 270 by redirecting authentication calls from the application 140 to the established server 150 to the migration module 270. The migration module 270 thereafter acts as the intermediary between the application 140, the established server 150, and the target server 160. In some embodiments, data used by the migration module 270 to locate and authenticate to the established server 150 and the target server 160 may be stored in the binding module 280.

The receive call operation 320 receives data related to authentication from the application 140 redirected to the migration module 270. The data related to authentication typically includes a user name and password passed in clear text. In some embodiments, the migration module 270 submits a user name and password in clear text to authenticate to the established server 150 and the target server 160. In some embodiments, the migration module 270 uses a cryptographic hash function such as MD5 or SHA1 generate a hash value that is submitted to authenticate to the established server 150 and the target server 160. The depicted authentication data migration method 300 is not compatible with servers using challenge-response authentication methods. However, use of hashed passwords and encrypted communication increases the security of the authentication data migration method 300.

The validate user operation 330 attempts to authenticate the user 110 by submitting the credential 125 to the target server 160 via a server request 264. In some embodiments, the migration module 270 submits a hash value of the credential 125. In some embodiments, the migration module 270 uses the Kerberos authentication service to authenticate to the target server 160.

The user validated test 335 determines whether a user object representing the user 110 was validated on the target server 160 by the validate user operation 330. The user validated test 335 may be used to determine whether there is a need for a new user object to be created on the target server 160 for a new user 110. If the user object was validated, the authentication data migration method 300 continues with the error test 340. If the user object was not validated on the target server 160, the authentication data migration method 300 continues with the create user test 380. In one embodiment, the user validated test 335 is only performed if a configuration setting in the binding module 280 indicates that a new user object is to be created on the target server 160 corresponding to a new user 110.

The error test 340 determines whether the migration module 270 was able to successfully authenticate the user 110 to the target server 160. If no error is returned by the target server 160, the authentication data pertaining to the user 110 has already been migrated to the target server 160, and the authentication data migration method 300 ends 390. If an error condition is returned from the target server 160, then the credential 125 submitted by the user 110 is not valid, and the authentication data migration method 300 continues with the authenticate user operation 350.

The authenticate user operation 350 attempts to authenticate the user 110 by submitting the credential 125 to the established server 150 via a credential 144. In some embodiments, the migration module 270 submits a hashed value of the credential 125.

The error test 360 determines whether the migration module 270 was able to successfully authenticate the user 110 to the established server 150. If an error is returned by the established server 150, it indicates that the user 110 has submitted an invalid credential and the authentication data migration method 300 ends 390. If no error is returned by the established server 150 to the migration module 270, the user has submitted a valid credential, but the authentication data pertaining to the user 110 has not yet been migrated to the target server 160 and the authentication data migration method 300 continues with the migrate authentication data operation 370.

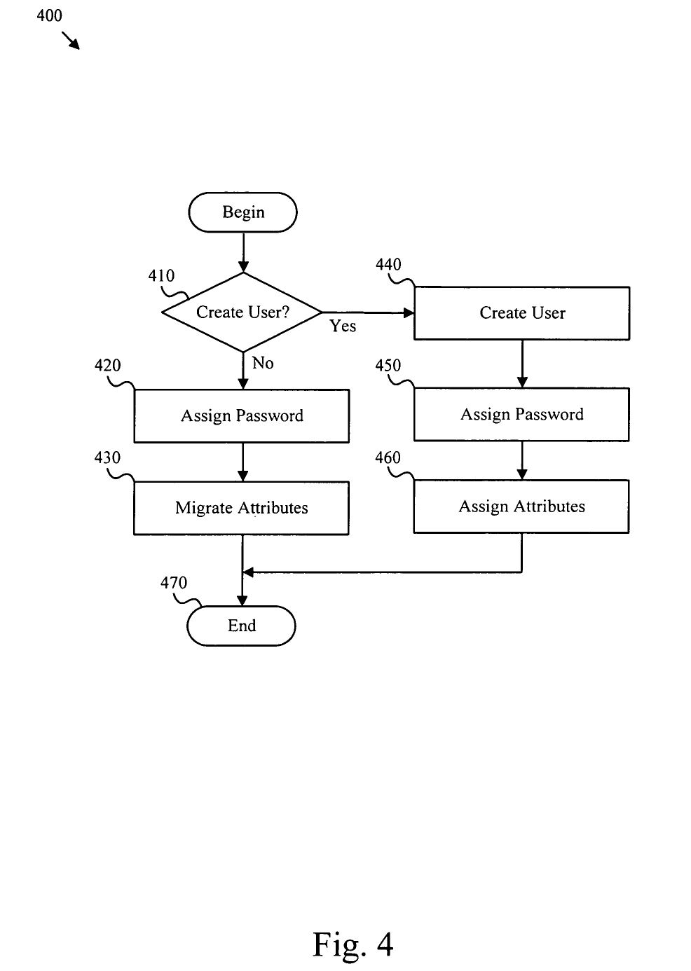

The migrate authentication data operation 370 migrates authentication data pertaining to the user 110 from the established server 150 to the target server 160. In some embodiments, the migrate authentication data operation 370 creates a new user object corresponding to the user 110 on the target server 160. In the embodiment depicted in FIG. 3, new user objects are created in a separate create user operation 385. In one embodiment, the migrate authentication data operation 370 assigns attributes to a new or existing user object in accordance with the user migration method 400 depicted in FIG. 4. In some embodiments, a user object pertaining to the user 110 is created on the target server 160 prior to the migrate authentication data operation 370, and the migrate authentication data operation 370 modifies the password of the user object corresponding to the user 110 on the target server 160. In some embodiments, the migrate authentication data operation 370 may create or modify attributes associated with the user object on the target server 160 pertaining to the user 110. In some embodiments, the migrate authentication data operation 370 may add an entry to an error log or event notification system if any aspect of the migrate authentication data operation 370 fails.

The create user test 380 ascertains whether a new user object on the target server 160 corresponding to a new user 110 should be created. In one embodiment, the create usertest 380 is controlled by a configuration setting in the binding module 280. If the configuration setting indicates that a new user object is not to be created, the authentication data migration method 300 ends 390. If the configuration setting indicates that a new user object is to be created, the authentication data migration method 300 continues with the create user operation 385. In some embodiments, new user objects are automatically created by the migrate authentication data operation 370. If the configuration setting indicates that a new user object is not to be created, the authentication data migration method 300 continues with the migrate authentication data operation 370.

The create user operation 385 creates a user object on the target server 160 corresponding to a new user 110. In various embodiments, the create user operation 385 may assign a password to the user object or the create user operation 385 may obtain a password input by the user 110. The create user operation 385 may create data attributes associated with the user object and assign default values to the data attributes.

FIG. 4 is a flow chart diagram illustrating one embodiment of a user migration method 400 of the present invention. The user migration method 400 assigns values to data fields associated with a user object on the target server 160. The data values assigned may be migrated from the established server 150.

In one embodiment, the user migration method 400 creates a new user object on the target server 160 corresponding to a new user 110 and assigns default values to data fields associated with the new user object. In one embodiment, the create user method 400 is used in accordance with the migrate authentication data operation 370 depicted in FIG. 3. The create user method 400 includes a create user test 410, an assign password operation 420, a migrate attributes operation 430, a create user operation 440, an assign password operation 450, and an assign attributes operation 460.

The create user test 410 determines whether a new user object is to be created on the target server 160 corresponding to a new user 110. In one embodiment, the create user test 410 creates new users on the target server 160 as indicated by a configuration setting in the binding module 280. If a new user is to be created, the create user method 400 continues with the create user operation 440, otherwise the create user method 400 continues with the assign password operation 420.

The assign password operation 420 assigns a password to the user object on the target server 160 corresponding to the user 110. In some embodiments, the established server 150 stores a hash value calculated from the password, not the password itself, and the password can not be recovered using the hash value. The migration module 270 intercepts the password for the user 110 during authentication to the established server 150. The password may then be assigned to the user object on the target server 160 using the native method for password assignment used by the authentication system on the target server 160.

The migrate attributes 430 migrates data fields from the user object on the established server 150 corresponding to the user 110, to the user object on the target server 160 corresponding to the same user 110. Attributes associated with a user 110 may include the user's full name, office address, mail stop, phone number, or the like. In one embodiment, the correspondence between user attributes on the established server 150 and user attributes on the target server 160 are specified in the binding module 280.

The create user operation 440 creates a new user object on the target server 160 corresponding to the user 110. Creating new user objects may be desirable in applications such as a web-based service or the like, where a user 110 is permitted to create their own new user account. The create user operation 440 creates a new user object on the target server 160, even though a corresponding user object does not exist in the established server 150. New user accounts are thereby created on the target server 160 as existing user accounts are migrated from the established server 150.

The assign password operation 450 assigns a password to the new user object created on the target server 160 by the create user operation 440. In one embodiment, the assign password operation 450 obtains a password to be assigned to the user account from the user 110. The assign password operation 450 assigns the password to the user account on the target server 160 using the native password assignment method used by the authentication system on the target server 160.

The assign attributes operation 460 assigns values to the attributes associated with the new user object created on the target server 160 by the create user operation 440. In one embodiment, the binding module 280 contains default values to be assigned to attributes associated with new user objects on the target server 160

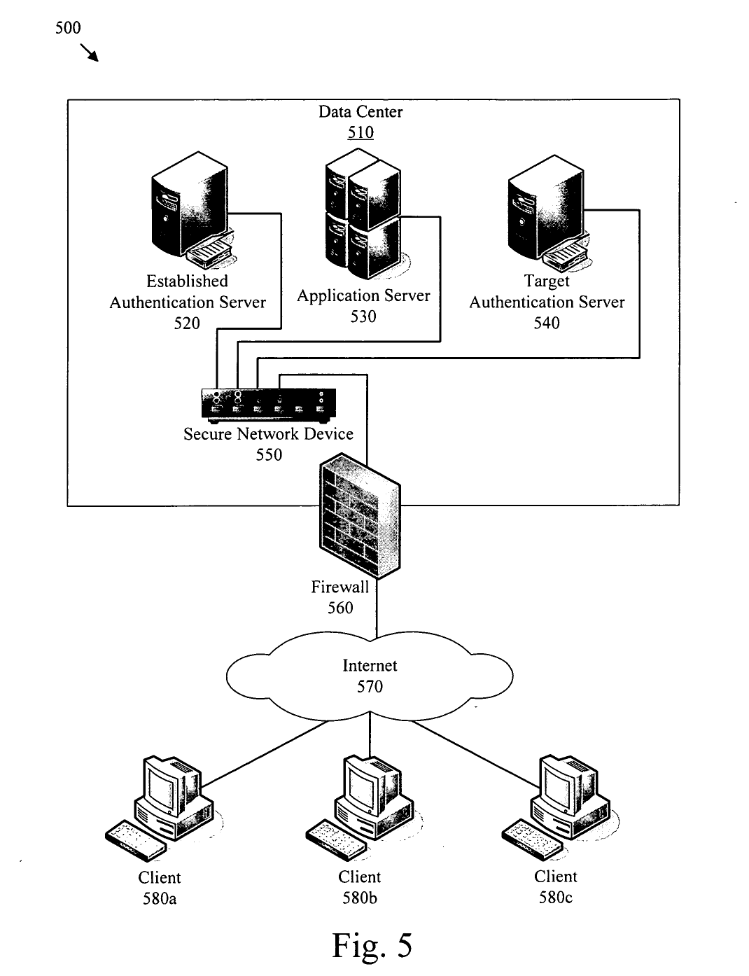

FIG. 5 is a network diagram illustrating a particular embodiment of an authentication data migration system of the present invention, namely the authentication data migration system 500. The authentication data migration system includes a data center 510, an established authentication server 520, an application server 530, a target authentication server 540, a secure network device 550, a firewall 560, the internet 570, and clients 580. The authentication data migration system 500 facilitates real-time migration of data related to authentication from the established authentication server 520 to the target authentication server 540 in an environment of enhanced security.

In the embodiment of the authentication data migration system 500 depicted in FIG. 5, the application server 530 hosts the components of the application server 130 depicted in FIG. 2, including the application 140, the migration module 270, and the binding module 280. Authentication requests may originate at clients 580 connected through the internet 570 or at the application server 530. Authentication credentials passed from the application server 530 to the established authentication server 520 and the target authentication server 540 are transmitted through the secure network device 550 that serves a private network that exists within the data center 510. In various embodiments, the secure network device 550 may be a switch, router, hub, or the like. When the authentication system running on an established authentication server 520 accepts authentication credentials in clear text, the authentication data migration system 500 may facilitate secure transmission of authentication credentials by transmitting them only on the private network within the data center 510.

The present invention facilitates real-time migration of data relating to authentication. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for real-time migration of data related to authentication, the apparatus: comprising:
a migration module configured to receive an authentication credential and submit the authentication credential to a first and a second authentication server;
a binding module configured to redirect an authentication credential intended for the first authentication server to the migration module; and
the migration module further configured to automatically migrate data corresponding to the authentication credential from the first authentication server to the second authentication server.

2. The apparatus of claim 1, wherein the authentication credential comprises a user name and password.

3. The apparatus of claim 1, wherein the authentication credential comprises clear text.

4. The apparatus of claim 1, wherein the binding module is further configured to specify settings related to authentication for the first and second servers.

5. The apparatus of claim 1, wherein the binding module is further configured to specify settings related to creating or modifying user objects on the second server.

6. The apparatus of claim 1, wherein the binding module is further configured to specify settings related to assigning passwords on the second server.

7. The apparatus of claim 1, wherein the second server is an Active Directory server.

8. The apparatus of claim 1, wherein data related to authentication is encrypted.

9. The apparatus of claim 8, wherein the data related to authentication is encrypted using Kerberos.

10. A method for real-time migration of data related to authentication, the method comprising:
redirecting authentication credentials intended for a first authentication server to a migration module;
receiving an authentication credential and submitting the authentication credential to the first authentication server and a second authentication server; and
migrating data corresponding to the authentication credential from the first authentication server to the second authentication server.

11. The method of claim 10, further comprising authenticating the particular user on the second server previous to migrating data related to authentication.

12. The method of claim 10, wherein migrating authentication data comprises failing to authenticate the user on the second server prior to migrating authentication data from the first server.

13. The method of claim 10, wherein redirecting authentication credentials comprises intercepting remote procedure calls intended for the first authentication server.

14. The method of claim 10, wherein redirecting authentication credentials comprises referencing the local authentication process in a binding module.

15. The method of claim 10, wherein receiving a redirected authentication credential comprises receiving parameters via an authentication protocol used on the first authentication server.

16. The method of claim 10, wherein receiving a redirected authentication credential comprises receiving parameters from an application.

17. The method of claim 10, wherein receiving a redirected authentication credential comprises receiving parameters from a local application.

18. The method of claim 10, wherein migrating authentication data comprises creating a user on the second server corresponding to the particular user.

19. The method of claim 10, wherein migrating authentication data comprises changing a user password on the second server.

20. The method of claim 10, wherein migrating authentication data comprises creating or modifying data fields associated with a user object on the second server.

21. The method of claim 10, wherein migrating authentication data comprises creating user objects on the second server duplicating user objects on the first server.

22. The method of claim 20, wherein migrating authentication data further comprises assigning default passwords to user objects on the second server.

23. An apparatus for real-time migration of data related to authentication, the apparatus comprising:
means for redirecting authentication credentials intended for a first authentication server to a migration module;
means for receiving an authentication credential relating to a particular user with the migration module; and
means for migrating data corresponding to the authentication credential from the first authentication server to a second authentication server.

24. A system for real-time migration of data related to authentication, the system comprising:
a first server configured to authenticate users by receiving an authentication credential;
a second server configured to authenticate users by receiving an authentication credential;
a migration module configured to receive an authentication credential and submit the authentication credential to the first and second servers;
a binding module configured to redirect an authentication credential intended for the first authentication server to the migration module; and
the migration module further configured to automatically migrate data corresponding to the authentication credential from the first authentication server to the second authentication server.

25. The system of claim 24, further comprising an application configured to receive authentication credentials.

26. The system of claim 25, wherein the migration module is further configured to receive authentication credentials from the application.

27. The system of claim 25, wherein the application is configured to run on an application server.

28. The system of claim 27, wherein the application server is configured to host the migration module.

29. The system of claim 24, wherein the second server is an Active Directory server.

30. A computer readable medium comprising computer readable program code comprising operations for real-time migration of data related to authentication, the operations comprising:
receiving an authentication credential and submitting the authentication credential to a first and a second authentication server;
redirecting authentication credentials intended for the first authentication server to a migration module; and
migrating data corresponding to the authentication credential from the first authentication server to the second authentication server.

31. The computer readable medium of claim 30, wherein the operations further comprise authenticating the particular user on the second server previous to migrating data related to authentication.
